(19) United States
(12) Patent Application Publication
(10) Pub. No.: US 2018/0216937 A1
(43) Pub. Date: Aug. 2, 2018

(54) METHOD FOR LOCALIZING A VEHICLE HAVING A HIGHER DEGREE OF AUTOMATION ON A DIGITAL MAP

(71) Applicant: Robert Bosch GmbH, Stuttgart (DE)

(72) Inventors: Holger Mielenz, Ostfildern (DE); Jan Rohde, Stuttgart (DE)

(21) Appl. No.: 15/879,592

(22) Filed: Jan. 25, 2018

(30) Foreign Application Priority Data
Feb. 2, 2017 (DE) 102017201664.7

(51) Int. Cl. G01C 21/00; G05D 1/02; G06T 7/73; G06K 9/00; G01C 21/32

(52) U.S. Cl. CPC G01C 21/005; G05D 1/0231; G06T 7/75; G05D 2201/0213; G01C 21/32; G06T 2207/30252; G06K 9/00805

(57) ABSTRACT

A method for localizing a more highly automated vehicle (HAV) on a digital map, includes detecting features of semi-static objects in an environment of the HAV with the aid of at least one first sensor, transmitting the features of the semi-static objects to an evaluation unit, classifying the semi-static objects, wherein the feature ‘semi-static’ is assigned to the semi-static objects as the result of the classification, transferring the features of the semi-static objects into a local environmental model of the HAV, the local environmental model including at least selected features of the semi-static objects in the form of expanded landmarks, transmitting the local environmental model to the HAV in the form of a digital map, and localizing the HAV with the aid of the digital map. A corresponding system and a computer program are also described.

### CROSS REFERENCE

The present application claims the benefit under 35 U.S.C. § 119 of German Patent Application No. DE 102017201664.7 filed on Feb. 2, 2017, which is expressly incorporated herein by reference in its entirety.

### FIELD

The present invention relates to a method and to a system for localizing a vehicle having a higher degree of automation (HAV) on a digital map.

### BACKGROUND INFORMATION

In view of an increase in the degree to which vehicles are automated, driver-assistance systems of an ever more complex design are used. Driver-assistance systems and functions of this type, such as more highly automated driving or fully automated driving, require a large number of sensors in the vehicle that allow for an exact detection of the vehicle environment. Herein, more highly automated refers to all degrees of automation that correspond to an automated longitudinal and transverse guidance with increasing system responsibility, e.g., partially automated, highly automated or fully automated driving, within the definition of the Bundesanstalt für Straßenwesen (BASt) (Federal Institute for Road Management). In order to control a motor vehicle in such a more highly automated manner, it is necessary, for instance, to locate the motor vehicle itself, to guide it in a preferred traffic lane and to execute driving maneuvers such as a parking maneuver inside a parking lot.

With the aid of different vehicle-internal ambient-environment sensors, e.g., radar sensors, cameras, driving-dynamics sensors, GPS (global positioning system) and/or digital maps, a representation of the vehicle environment, known as an environmental model, is able to be constructed, the most highly prioritized goal being the achievement of greater accuracy and safety as well as a greater visual range in comparison with individual data sources.

In view of driving with a greater degree of automation, in particular, high system availability is required. Currently implemented driver-assistance systems for more highly automated vehicles place the focus on improving the accuracy, visual range and also greater reliability of the detection.

Various conventional methods for carrying out such a localization of a more highly automated vehicle (HAV) on a digital map are available. Among them, for example, are methods in which only the particular number or density of landmarks required for a sufficiently precise localization is transmitted to the HAV, thereby making it possible to save data rates for the transmission from the server to the vehicle or also reduce the computational complexity in the vehicle and accelerate the propagation time. In this context it is disadvantageous, however, that landmarks may also be hidden and thus are unable to be detected by the HAV. This not only results in an unnecessary transmission of data but also a possibly poorer localization accuracy since not enough information is available for matching purposes. However, this is in contradiction with high system reliability, which is required for automated driving.

It is an object of the present invention to provide a better method for localizing a more highly automated vehicle (HAV) on a digital map.

### SUMMARY

Advantageous example embodiments and further developments of the present invention are described herein.

According to one aspect of the present invention, a method for localizing a more highly automated vehicle (HAV) on a digital map is provided, which includes the following steps:
S1 Detecting features of semi-static objects in an environment of the HAV with the aid of at least one first sensor;
S2 Transmitting the features of the semi-static objects to an evaluation unit;
S3 Classifying the semi-static objects, whereby the feature “semi-static” is allocated to the semi-static objects as the result of the classification;
S4 Transferring the features of the semi-static objects into a local environmental model of the HAV, the local environmental model including at least selected features of the semi-static objects in the form of expanded landmarks;
S5 Transmitting the local environmental model to the HAV in the form of a digital map; and
S6 Localizing the HAV using the digital map.

According to the present invention, a driver-assistance system for more highly automated vehicles is thus provided, which detects landmarks for localizing the vehicle with the aid of vehicle-internal ambient-environment sensors. Furthermore, the landmarks are classified and the attribute “semi-static” may possibly be allocated to them. In principle, it is possible that the vehicle furthermore provides the server with the particular information that enables the server to update a hypothesis via the introduced attribute “hidden” or “visible”. By omitting the hidden landmarks in the transmission of the local environmental model in the form of a digital map to the HAV, the robustness and/or the accuracy of the localization is/are increased since the driver-assistance system of the HAV as well as the allocated ambient-environment sensors of the HAV in this case do not waste any computational capacity and time for locating the landmark that is not visible anyway.

According to one specific embodiment, it is provided that the at least one first sensor is a stationary infrastructure sensor, and that the at least one infrastructure sensor is mounted in particular on a streetlight or on a light-signal system, and/or that the at least one first sensor is mounted on the HAV, and/or that the at least one first sensor is mounted on an additional HAV.

The step of detecting is preferably carried out using a multitude of first sensors.

According to a further specific embodiment of the present invention, it is provided that the features of the semi-static objects include at least one of the features of contour, geo-position, color, dimensions, orientation in space, velocity and/or acceleration state.

Step S3 of classifying preferably takes place through a control of the at least one first sensor and/or through the evaluation unit. In addition, step S3 of classifying is also carried out at least with the aid of one of the features of contour, geo-position, color, dimensions, orientation in space, velocity and/or acceleration state of the semi-static objects. This achieves the particular technical advantage that vehicles are also able to detect and classify parked vehicles with the aid of the evaluation unit and the digital map, and—expanded by contour and color information—transmit this information to a server or to a back end in such a way that it is able to be utilized for deriving temporarily limited landmarks.

The evaluation unit is preferably a mobile edge computing server, and the mobile edge computing server is stationary, in particular.

According to one advantageous development, it is provided that step S4 of transferring the features of the semi-static objects into a local environmental model includes the step of geo-referencing the semi-static objects.

This achieves in particular the technical advantage that the driver-assistance system detects and classifies semi-static objects such as garbage cans, parked vehicles or trailers, and transmits their contour and geo-position to the server. The advantages of the method according to the present invention consist of an improvement in the robustness and the accuracy of the localization, in particular in an urban environment, because semantic landmarks such as curbstones, line markings, building corners and the like have high overlap rates on account of parked vehicles and such, and precisely these things may be utilized as new landmarks with the aid of the method according to the present invention. In this context, the server then calculates for the approaching vehicles on the basis of the driving trajectory and the available traffic-lane geometries whether an overlap probability exists for landmarks that are currently located in the environment of the HAV or may be located there in the future.

In one advantageous development, the respective method step of transmitting in steps S2 and S5 is carried out using a radio signal in each case.

In one further specific embodiment, it is provided that step S6 of localizing the HAV using the digital map includes that at least one of the features of the semi-static objects is detected by an ambient-environment sensor system of the HAV and that a control of the HAV-matching method commences in order to compare the at least one feature, detected by the ambient-environment sensor system, with the information from the map.

According to another specific embodiment, it is provided that the environmental model also includes landmarks in the form of static objects.

Another subject matter of the present invention is a system for localizing a more highly automated vehicle (HAV) on a digital map. The system includes at least one first sensor, which is designed to detect features of semi-static objects in an environment of the HAV. In addition, the system includes a communications interface, which is designed to transmit the features of the semi-static objects to an evaluation unit, and the evaluation unit is designed to perform a classification of the semi-static objects. The classification includes an allocation of the feature “semi-static” to the semi-static objects as a result of the classification. Moreover, the evaluation device is designed to transfer the features of the semi-static objects into a local environmental model of the HAV, the local environmental model including at least selected features of the semi-static objects in the form of expanded landmarks. The communications interface is designed to transmit the local environmental model to the HAV in the form of a digital map. The system furthermore includes a driver-assistance system or a control of the HAV, which is developed to perform a localization of the HAV using the digital map as well as ambient-environment sensors of the HAV.

A computer program, which includes a program code for carrying out the method according to the present invention when the computer program is executed on a computer, is another subject matter of the present invention.

The approach according to the present invention in particular provides the technical advantage of improving the robustness and the accuracy in the localization of an HAV, in particular in an urban environment, because semantic landmarks such as curbstones, line markings, building corners, etc. feature high overlap rates on account of parked vehicle and the like, and precisely these things are able to be used as new landmarks with the aid of the present invention.

Although the present invention is mainly described in connection with passenger cars in the following text, it is not restricted to cars of this type but may be utilized by any kind of vehicle, truck and/or passenger car.

Additional features, application possibilities and advantages of the present invention result from the following description of the exemplary embodiments of the present invention that are illustrated in the figures. It should be noted that the illustrated features are of merely descriptive character and may also be used in combination with features of other further developments described above and are not intended to restrict the present invention in any way.

### BRIEF DESCRIPTION OF THE DRAWINGS

Below, the present invention is described in greater detail on the basis of preferred exemplary embodiments. Matching reference numerals are used for identical features. The figures are schematic.

FIG. 1 show a plan view of a situation in road traffic, in which the example method according to the present invention for localizing an HAV is used.

FIG. 2 shows a flow diagram of one specific embodiment of the method according to the present invention.

### DETAILED DESCRIPTION OF EXAMPLE EMBODIMENTS

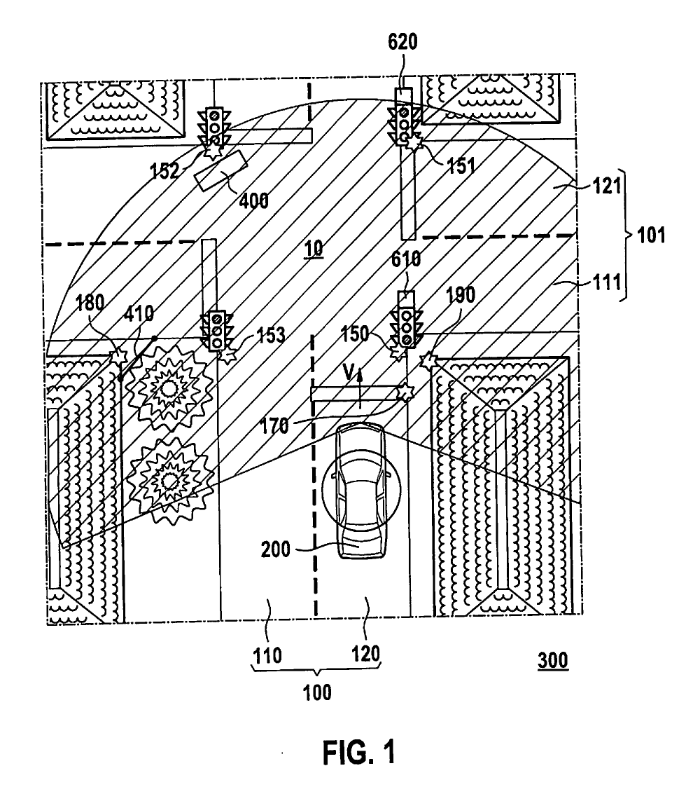

FIG. 1 shows a traffic node 10 where two road sections 100, 101 having two traffic lanes 110, 120, 111, 121 that are usable by an HAV 200 for driving intersect. The traffic at traffic node 10 is controlled by light-signal systems 150, 151, 152, 153, among other things. In addition, a first building corner 180 and a second building corner 190 are located in the environment of traffic node 10. In the framework of this example, it should be assumed that light-signal systems 150, 151, 152, 153, building corners 180, 190 as well as a stop line 170 are available in geo-referenced form and as permanent landmarks for setting up a digital environmental model.

For example, this means that certain features of building corner 180 required to identify building corner 180 as well as its position in a suitable coordinate system in digital form are stored in a data memory for setting up an environmental model for an HAV. The features required for identifying the building corner may be its position, the dimensions or color of the abutting walls, their extension in the vertical direction and similar things. The data memory, for example, may be a local evaluation unit 300, e.g., a mobile edge computing server, or a remote server (not shown). Within the framework of the exemplary embodiment, it is assumed that the data memory is part of local evaluation unit 300.

The use of light-signal systems 150, 151, 152, 153, of building corners 180, 190 and also of stop line 170 as permanent landmarks includes that their position and the features required for their identification are able to be transmitted to an HAV. After receiving the corresponding information, a driver-assistance system of the HAV is able to find the permanent landmarks with the aid of what is known as matching methods and a corresponding onboard sensor system, e.g., cameras, and exploit their position relative to the HAV for localizing the HAV on a digital map.

In addition, FIG. 1 shows a first object 400 as well as a second object 410. For example, first object 400 may be a temporarily placed construction container for roadwork, while second object 410 is a temporarily erected display sign, for instance. Within the framework of the present application, first object 400 and second object 410 are referred to as semi-static objects because they are immovable at the time when they are crossed by HAV 200, but do not remain at their position long enough to be suitable as permanent landmarks.

As can be gathered from FIG. 1, first object 400 and second object 410 are able to be detected by two first sensors 610, 620. First sensors 610, 620 may be stationary infrastructure sensors, for example, and sensors 610, 620 are fixed in place on light-signal systems 150 and 151, respectively, in the exemplary embodiment of FIG. 1. The number of first sensors 610, 620 is not restricted to two, but any desired number of first sensors 610, 620 is basically possible.

However, it is also possible that at least one of sensors 610, 620 is mounted on HAV 200, and/or that at least one of sensors 610, 620, such as in the form of an environmental camera, is installed on a further HAV, which is not shown.

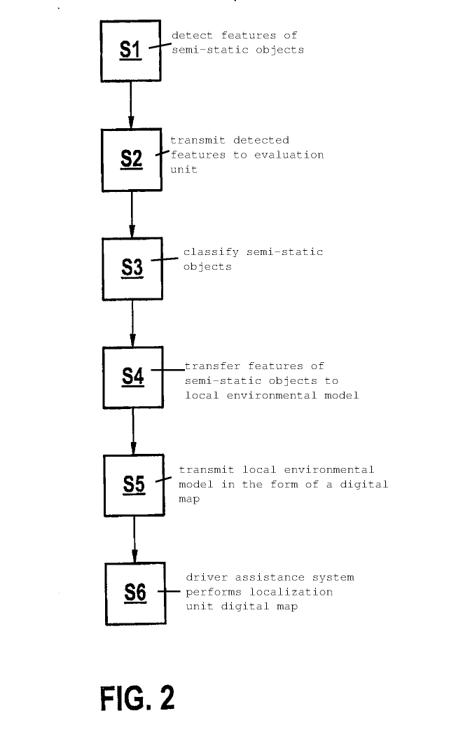

In a first step S1 of the method according to the present invention, features of semi-static objects 400, 410 in an environment of HVA 200 are detected with the aid of first sensors 610, 620, see also FIG. 2.

The features of semi-static objects 400, 410 may be one or more of the feature(s) of contour, geo-position, color, dimensions, orientation in space, velocity and/or acceleration state of detected semi-static objects 400, 410. The geo-position feature in particular may involve length specifications in the form of directions relative to respective first sensors 610, 620, measured by different first sensors 610, 620 in what is known as ‘direction finding’. The geo-position of a semi-static object 400, 410 is indicated as the point of intersection of the two directional indications by respective first sensors 610, 620.

In a step S2, the detected features of semi-static objects 400, 410 are transmitted to evaluation unit 300. The transmission preferably takes place via a radio signal, which is why both evaluation unit 300 and the first sensor have a corresponding communications interface.

Step S3 shown in FIG. 2 includes the classification of semi-static objects 400, 410, in which the feature ‘semi-static’ is assigned to semi-static objects 400, 410 as the result of the classification provided corresponding criteria are met. For example, one or more of the features of contour, geo-position, color, dimensions, orientation in space, velocity, and/or acceleration state of the semi-static objects 400, 410 may serve as criteria for classifying the recorded objects as ‘semi-static’.

The classification may be performed both by a control unit allocated to the at least one sensor, i.e. even before the detected features of semi-static objects 400, 410 are transmitted to evaluation unit 300, and/or by evaluation unit 300 after it has received the features of semi-static objects 400, 410.

In step S4, the features of semi-static objects 400, 410 are transferred into a local environmental model of HAV 200. The local environmental model includes at least selected features of semi-static objects 400, 410 in the form of expanded landmarks. In the example of FIG. 4, first object 400 and second object 410 are classified as semi-static objects. When evaluation unit 300 sets up the local environmental model, the particular dimensions and colors of semi-static objects 400, 410, for example, as well as a respective geo-reference that represents the location of semi-static objects 400, 410 are transmitted. It is advantageous in this context if as many first sensors 610, 620 as possible are located at traffic node 180 because in such a case the geo-referencing of semi-static objects 400, 410 may generally be carried out more precisely than in the case of fewer first sensors 610, 620.

Step S4 of transferring the features of semi-static objects 400, 410 into a local environmental model preferably includes the step of geo-referencing semi-static objects 400, 410.

The local environmental model, which is transmitted to HAV 200 in the form of a digital map in step S5, now includes semi-static objects 400, 410 in the form of expanded landmarks.

In step S6, the driver-assistance system of HAV 200 then performs the localization of HAV 200 using the digital map. In this context, both the expanded landmarks, i.e. the geo-references of semi-static objects 400, 410, and possibly transmitted permanent landmarks, i.e. static objects, as well as further localization information are used, e.g., the global positioning system (GPS).

In order to identify expanded landmarks, step S6 of localizing HAV 200 with the aid of the digital map therefore preferably includes that at least one of the features of semi-static objects 400, 410 is recognized by an ambient-environment sensor system of HAV 200 and that a driver-assistance system or a control of HAV 200 uses matching methods in order to compare the at least one feature perceived by the ambient environment sensor system to the information from the map.

As can be gathered from the description above, FIG. 1 also shows a system for localizing HAV 200 on a digital map, the system including the following:
Two first sensors 610, 620, the first sensors being designed to detect features of semi-static objects 400, 410 in an environment of HAV 200;
a communications interface, which is designed to transmit the features of semi-static objects 400, 410 to evaluation unit 300, and evaluation unit 300 is designed
to carry out a classification of semi-static objects 400, 410, and the classification includes that the feature ‘semi-static’ be assigned to semi-static objects 400, 410 as the result of the classification provided corresponding criteria are met, and it is furthermore developed
to transfer the features of semi-static objects 400, 410 into a local environmental model of HAV 200, and the local environmental model includes at least selected features of semi-static objects 400, 410 in the form of expanded landmarks, the communications interface furthermore being designed to transmit the local environment model in the form of a digital map to HAV 200; and
a driver-assistance system or a control of HAV 200, which is designed to perform a localization of HAV 200 with the aid of the digital map and ambient-environment sensors of HAV 200.

The present invention is not restricted to the described and illustrated exemplary embodiment. Instead, it also encompasses all further developments within the framework of the present invention.

In addition to the described and illustrated specific embodiments, further specific embodiments, which may include further variations as well as combinations of features, are possible.

What is claimed is:

1. A method for localizing a more highly automated vehicle (HAV) on a digital map, the method comprising:
detecting features of semi-static objects in an environment of the HAV with the aid of at least one first sensor;
transmitting the features of the semi-static objects to an evaluation unit;
classifying the semi-static objects, and assigning the feature ‘semi-static’ to the semi-static objects as the result of the classification;
transferring the features of the semi-static objects into a local environmental model of the HAV, the local environmental model including at least selected features of the semi-static objects in the form of expanded landmarks;
transmitting the local environmental model to the HAV in the form of a digital map; and
localizing the HAV using the digital map.

2. The method as recited in claim 1, wherein the at least one first sensor is a stationary infrastructure sensor, and the at least one infrastructure sensor is mounted on at least one of: (i) a streetlight, (ii) a light-signal system, and (iii) the HAV.

3. The method as recited in claim 1, wherein the detecting step is carried out with the aid of a multitude of first sensors.

4. The method as recited in claim 1, wherein the features of the semi-static objects include at least one of the features of: contour, geo-position, color, dimensions, orientation in space, velocity, and acceleration state.

5. The method as recited in claim 1, wherein the classifying step is carried out at least one of: (i) by a control of the at least one first sensor, and (ii) by the evaluation unit, and wherein the classifying step is performed at least on the basis of one of the features of contour, geo-position, color, dimensions, orientation in space, velocity, and acceleration state of the semi-static objects.

6. The method as recited in claim 1, wherein the evaluation unit is a mobile edge computing server, and the mobile edge computing server is stationary.

7. The method as recited in claim 1, wherein the step of transferring the features of the semi-static objects into a local environmental model includes geo-referencing the semi-static objects.

8. The method as recited in claim 1, wherein the environmental model transferred in the step includes at least one of the features of contour, geo-position, color, dimensions, orientation in space, velocity, and acceleration state of the semi-static objects.

9. The method as recited in claim 1, wherein the steps of transmitting the features and transmitting the local environment model take place using radio signals.

10. The method as recited in claim 1, wherein the step of localizing the HAV with the aid of the digital map includes that at least one of the features of the semi-static objects is detected by an ambient-environment sensor system of the HAV and that one of a driver-assistance system or a control of the HAV uses matching methods in order to compare the at least one feature detected with the aid of the ambient environment sensor system to the information from the map.

11. The method as recited in claim 1, wherein the environmental model includes landmarks in the form of static objects.

12. A system for localizing a more highly automated vehicle (HAV) on a digital map, comprising:
at least one first sensor designed to detect features of semi-static objects in an environment of the HAV;
a communications interface designed to transmit the features of the semi-static objects to an evaluation unit and
the evaluation unit designed to carry out a classification of the semi-static objects, the classification including that the feature ‘semi-static’ be assigned to the semi-static objects as the result of the classification, and the evaluation unit is furthermore designed to transfer the features of the semi-static objects into a local environment model of the HAV, the local environment model including at least selected features of the semi-static objects in the form of expanded landmarks, and wherein the communications interface is furthermore designed to transmit the local environment model in the form of a digital map to the HAV; and
one of a driver-assistance system or a control of the HAV, which is designed to perform a localization of the HAV using the digital map and ambient-environment sensors of the HAV.

13. A non-transitory computer-readable storage medium on which is stored a computer program including program code for localizing a more highly automated vehicle (HAV) on a digital map, the computer program, when executed by a computer, causing the computer to perform:
detecting features of semi-static objects in an environment of the HAV with the aid of at least one first sensor;
transmitting the features of the semi-static objects to an evaluation unit;
classifying the semi-static objects, and assigning the feature ‘semi-static’ to the semi-static objects as the result of the classification;
transferring the features of the semi-static objects into a local environmental model of the HAV, the local environmental model including at least selected features of the semi-static objects in the form of expanded landmarks;
transmitting the local environmental model to the HAV in the form of a digital map; and
localizing the HAV using the digital map.
